(19) United States
(12) Patent Application Publication
(10) Pub. No.: US 2025/0322300 A1
(43) Pub. Date: Oct. 16, 2025

(54) METHOD AND SYSTEM FOR AUTOMATIC AI MODEL SELF-HEALING

(71) Applicant: JPMorgan Chase Bank, N.A., New York, NY (US)

(72) Inventors: James MASSA, Water Mill, NY (US); Mitali BASAK, Parsippany, NJ (US); Nithya SUBBARAMAN, Bangalore (IN); Smruti SWAIN, Nayagarh (IN)

(73) Assignee: JPMorgan Chase Bank, N.A., New York, NY (US)

(21) Appl. No.: 18/677,438

(22) Filed: May 29, 2024

(30) Foreign Application Priority Data
Apr. 15, 2024 (IN) 202411030150

(51) Int. Cl. G06N 20/00

(52) U.S. Cl. CPC G06N 20/00

(57) ABSTRACT

A method and system for using AI techniques to monitor the performance of an AI model and automatically perform an appropriate corrective action when necessary are provided. The method includes: receiving first data that relates to an AI model; generating, based on the received first data, at least one key performance indicator (KPI) that relates to the AI model; comparing each of the at least one KPI to at least one configurable threshold; assigning, based on a result of the comparing, a model health rating; and when the model health rating is less than a predetermined minimum acceptable health rating, performing, by the at least one processor, at least one corrective action that causes an increase in the model health rating.

### CROSS-REFERENCE TO RELATED APPLICATIONS

This application claims priority benefit from Indian Application No. 202411030150, filed on Apr. 15, 2024 in the India Patent Office, which is hereby incorporated by reference in its entirety.

### FIELD OF THE DISCLOSURE

This technology generally relates to methods and systems for performing end-to-end self-healing of an artificial intelligence (AI) model automatically, and more particularly to methods and systems for using AI techniques to monitor the performance of an AI model and automatically perform an appropriate corrective action when necessary.

### BACKGROUND INFORMATION

Maintaining AI model health is an expensive endeavor that requires highly trained data scientists. Currently, only data scientists are capable of understanding the quality of model results and have the ability to manually take corrective action to heal a misbehaving model.

For new AI models it is laborious and expensive to do model probability threshold tuning, hyper-parameter tuning, feature engineering, and user acceptance testing (UAT) for both initial model release and subsequent model retraining. Existing tooling does not tune probability thresholds and does not do feature engineering for derived features.

Furthermore, it is challenging to remember training experiments. Thus, it is hard to know if a model uses the optimal algorithm trained with optimal hyper-parameters and features and tuned with the optimal probability threshold to optimize key performance indicators (KPI).

Additionally, for existing models, it is difficult to know whether a model is behaving as expected. This is because the data underlying a model can drift (e.g., new data is input into the model). Data drift can degrade or break model performance and require model tuning or retraining.

Retraining models can be a laborious manual process that cannot realistically be done as frequently as required. As mandatory in the European Union (EU) under the General Data Protection Regulation (GDPR) a client's data must be deleted from the model if a client wishes for their data to be forgotten. Thus, the model must be retrained each time a client would like to be forgotten under GDPR regulations.

Accordingly, there is need for models that automatically maintain themselves in the vast majority of situations. For example, models that can tune their own probability threshold, or that can retrain and redeploy themselves altogether.

### SUMMARY

The present disclosure, through one or more of its various aspects, embodiments, and/or specific features or sub-components, provides, inter alia, various systems, servers, devices, methods, media, programs, and platforms for using AI techniques to monitor the performance of an AI model and automatically perform an appropriate corrective action when necessary.

According to an aspect of the present disclosure, a method for automatically monitoring a performance of an artificial intelligence (AI) model is provided. The method is implemented by at least one processor. The method includes: receiving, by the at least one processor, first data that relates to an AI model; generating, by the at least one processor based on the received first data, at least one key performance indicator (KPI) that relates to the AI model; comparing, by the at least one processor, each of the at least one KPI to at least one configurable threshold; assigning, by the at least one processor based on a result of the comparing, a model health rating; and when the model health rating is less than a predetermined minimum acceptable health rating, performing, by the at least one processor, at least one corrective action that causes an increase in the model health rating.

The performing of the at least one corrective action may include applying an AI algorithm that implements a machine learning technique with respect to a plurality of parameters associated with at least one from among the at least one KPI.

The performing of the at least one corrective action may further include executing a model tune-up. The executing of the model tune-up may include: calculating, by the at least one processor, a respective F1 score, a respective Matthews Correlation Coefficient (MCC), a respective Euclidean distance, a respective recall, a respective precision and a respective specificity for each corresponding one of a predetermined range of probability thresholds; identifying, by the at least one processor based on points derived from each of the F1 score, the Matthews Correlation Coefficient (MCC), the Euclidean distance, the recall, the precision and the specificity, a probability threshold; generating, by the at least one processor based on the identified probability threshold for each of the F1 score, the Matthews Correlation Coefficient (MCC), the Euclidean distance, the recall, the precision and the specificity, an updated model KPI; choosing, by the at least one processor based on the calculated updated model KPI, two of the identified probability thresholds; improving, by the at least one processor, the precision of the two identified probability thresholds by finding a KPI metric value for a plurality of intermediate points between the two identified probability thresholds using a configurable precision parameter; selecting, by the at least one processor, an optimal probability threshold value from the plurality of intermediate points with a maximum KPI metric value; and updating, by the at least one processor, the AI model based on the selected optimal probability threshold value.

The performing of the at least one corrective action may include executing a model trade-in. The executing of the model trade-in may include retraining, by the at least one processor, the AI model by using a range of hyper-parameters with respect to at least one set of second data that relates to the AI model and that has been generated more recently than the first data; and deploying, by the at least one processor, a retrained version of the AI model.

The performing of the at least one corrective action may further include executing a model trade-up. The executing of the model trade-up may include identifying, by the at least one processor, a new feature-set from the second data; training, by the at least one processor, a plurality of candidate AI models using the selected feature-set; generating, by the at least one processor based on a result of the training, a respective KPI metric for each of the plurality of candidate AI models; performing, by the at least one processor, hyper-parameter tuning of the plurality of candidate AI models by using a range of hyper-parameters; selecting, by the at least one processor based on the generated respective KPI metric and the hyper-parameter tuning, a new AI model from among the plurality of candidate AI models; and implementing, by the at least one processor, the selected new AI model.

The method may further include where the at least one KPI includes at least one from among a precision of the AI model that relates to a quality of a positive prediction made by the AI model, a recall of the AI model that relates to a percentage of relevant data points that are correctly identified by the AI model, a specificity that relates to a proportion of true negatives that are correctly identified by the AI model, an accuracy that relates to a percentage of classifications correctly identified by the AI model, and an F1 score of the AI model that is calculable based on the precision and the recall.

The method may further include displaying, on a graphical user interface, an image that illustrates a result of the model health rating.

The method may further include generating an explanation with respect to the model health rating being less than the predetermined minimum acceptable health rating, and outputting the generated explanation to the GUI for display thereon.

The method may further include where the explanation includes information that relates to feature weights used for determining the model health rating and a textual description that relates to how the feature weights have been determined.

According to another aspect of the present disclosure, a computing apparatus for automatically monitoring a performance of an artificial intelligence (AI) model is provided. The computing apparatus includes a processor; a memory; a display; and a communication interface coupled to each of the processor, the memory, and the display. The processor is configured to: receive, via the communication interface, first data that relates to an AI model; generate, based on the received first data, at least one key performance indicator (KPI) that relates to the AI model; compare each of the at least one KPI to at least one configurable threshold; assign, based on a result of the comparing, a model health rating; and when the model health rating is less than a predetermined minimum acceptable health rating, performing at least one corrective action that causes an increase in the model health rating.

The processor may be further configured to perform the at least one corrective action by applying an artificial intelligence (AI) algorithm that implements a machine learning technique with respect to a plurality of parameters associated with at least one from among the at least one KPI.

The processor may be further configured to perform the at least one corrective action by executing a model tune-up, and to execute the model tune-up by: calculating a respective F1 score, a respective Matthews Correlation Coefficient (MCC), a respective Euclidean distance, a respective recall, a respective precision and a respective specificity for each corresponding one of a predetermined range of probability thresholds; identifying, based on points derived from each of the F1 score, the Matthews Correlation Coefficient (MCC), the Euclidean distance, the recall, the precision and the specificity, a probability threshold; generating, based on the identified probability threshold for each of the F1 score, the Matthews Correlation Coefficient (MCC), the Euclidean distance, the recall, the precision and the specificity, an updated model KPI; choosing, based on the calculated updated model KPI, two of the identified probability thresholds; improving the precision of the two identified probability thresholds by finding a KPI metric value for a plurality of intermediate points between the two identified probability thresholds using a configurable precision parameter; selecting an optimal probability threshold value from the plurality of intermediate points with a maximum KPI metric value; and updating the AI model based on the selected optimal probability threshold value.

The processor may be further configured to perform the at least one corrective action by executing a model trade-in, and to execute the model trade-in by: retraining the AI model by using a range of hyper-parameters with respect to at least one set of second data that relates to the AI model and that has been generated more recently than the first data; and deploying a retrained version of the AI model.

The processor may be further configured to perform the at least one corrective action by executing a model trade-up, and to execute the model trade-up by: identifying a new feature-set from the second data; training a plurality of candidate AI models using the selected feature-set; generating, based on a result of the training, a respective KPI metric for each of the plurality of candidate AI models; performing hyper-parameter tuning of the plurality of candidate AI models by using a range of hyper-parameters; selecting, based on the generated respective KPI metric and the hyper-parameter tuning a new AI model from among the plurality of candidate AI models; and deploying the selected new AI model.

The at least one KPI may include at least one from among a precision of the AI model that relates to a quality of a positive prediction made by the AI model, a recall of the AI model that relates to a percentage of relevant data points that are correctly identified by the AI model, a specificity that relates to a proportion of true negatives that are correctly identified by the AI model, an accuracy that relates to a percentage of classifications correctly identified by the AI model, and an F1 score of the AI model that is calculable based on the precision and the recall.

The processor may be further configured to cause the display to display, via a graphical user interface (GUI), the model health rating.

The processor may be further configured to generate an explanation with respect to the model health rating being less than the predetermined minimum acceptable health rating, and to output the generated explanation to the GUI for display thereon.

The explanation may further include information that relates to feature weights used for determining the model health rating and a textual description that relates to how the feature weights have been determined.

According to yet another aspect of the present disclosure, a non-transitory computer readable storage medium storing instructions for automatically monitoring a performance of an artificial intelligence (AI) model is provided. The storage medium includes executable code which, when executed by a processor, causes the processor to: receive first data that relates to an AI model; generate, based on the received first data, at least one key performance indicator (KPI) that relates to the AI model; compare each of the at least one KPI to at least one configurable threshold; assign, based on a result of the comparing, a model health rating; and when the model health rating is less than a predetermined minimum acceptable health rating, perform at least one corrective action that causes an increase in the model health rating.

The executable code may further cause the processor to perform the at least one corrective action by applying an artificial intelligence (AI) algorithm that implements a machine learning technique with respect to a plurality of parameters associated with at least one from among the at least one KPI.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using AI techniques to monitor the performance of an AI model and automatically perform an appropriate corrective action when necessary.

FIG. 4 is a flowchart of an exemplary process for implementing a method for using AI techniques to monitor the performance of an AI model and automatically perform an appropriate corrective action when necessary.

FIG. 5 is a flow diagram that illustrates a process logic in a method for using AI techniques to monitor the performance of an AI model and automatically perform an appropriate corrective action when necessary, according to an exemplary embodiment.

FIG. 6 is a screenshot of a GUI displaying a set of metrics generated while executing a method for using AI techniques to monitor the performance of an AI model and automatically perform an appropriate corrective action when necessary, according to an exemplary embodiment.

FIG. 7 is a graph showing the distribution of four points for selecting the optimal probability threshold generated while executing a method for using AI techniques to monitor the performance of an AI model and automatically perform an appropriate corrective action when necessary, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

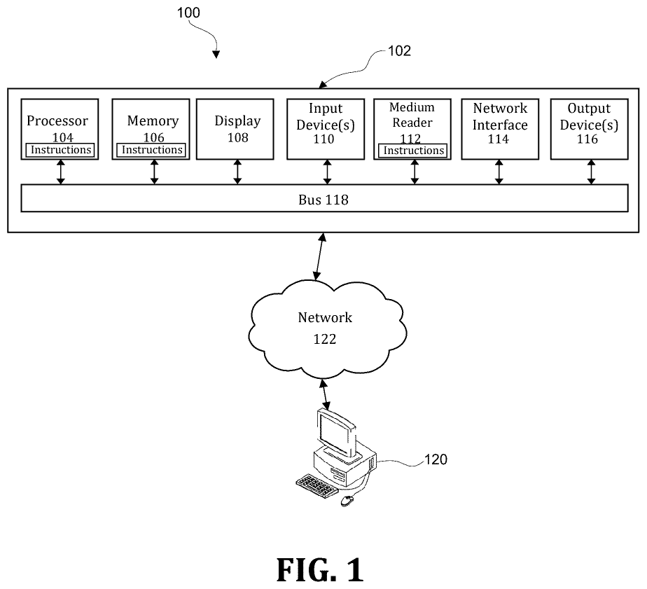

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

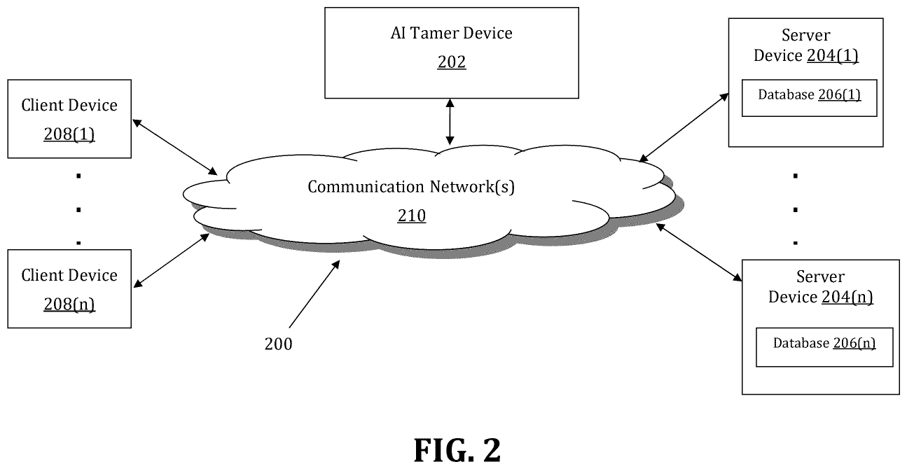

Referring to FIG. 2, a schematic of an exemplary network environment 200 for implementing a method for using AI techniques to monitor the performance of an AI model and automatically perform an appropriate corrective action when necessary, is illustrated. In an exemplary embodiment, the method is executable on any networked computer platform, such as, for example, a personal computer (PC).

The method for using AI techniques to monitor the performance of an AI model and automatically perform an appropriate corrective action when necessary may be implemented by an AI Tamer device 202. The AI Tamer device 202 may be the same or similar to the computer system 102 as described with respect to FIG. 1. The AI Tamer device 202 may store one or more applications that can include executable instructions that, when executed by the AI Tamer device 202, cause the AI Tamer device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AI Tamer device 202 itself, may be located in virtual server(s) running in a cloud-based computing environment rather than being tied to one or more specific physical network computing devices. Also, the application(s) may be running in one or more virtual machines (VMs) executing on the AI Tamer device 202. Additionally, in one or more embodiments of this technology, virtual machine(s) running on the AI Tamer device 202 may be managed or supervised by a hypervisor.

In the network environment 200 of FIG. 2, the AI Tamer device 202 is coupled to a plurality of server devices 204(1)-204(n) that hosts a plurality of databases 206(1)-206(n), and also to a plurality of client devices 208(1)-208(n) via communication network(s) 210. A communication interface of the AI Tamer device 202, such as the network interface 114 of the computer system 102 of FIG. 1, operatively couples and communicates between the AI Tamer device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AI Tamer device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and AI Tamer devices that efficiently implement a method for using AI techniques to monitor the performance of an AI model and automatically perform an appropriate corrective action when necessary.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AI Tamer device 202 may be a standalone device or integrated with one or more other devices or apparatuses, such as one or more of the server devices 204(1)-204(n), for example. In one particular example, the AI Tamer device 202 may include or be hosted by one of the server devices 204(1)-204(n), and other arrangements are also possible. Moreover, one or more of the devices of the AI Tamer device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AI Tamer device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to the AI model and data that relates to configurable threshold criteria.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the AI Tamer device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the AI Tamer device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the AI Tamer device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AI Tamer device 202, the server devices 204(1)-204(n), or the client devices 208(1)-208(n), for example, may be configured to operate as virtual instances on the same physical machine. In other words, one or more of the AI Tamer device 202, the server devices 204(1)-204(n), or the client devices 208(1)-208(n) may operate on the same physical device rather than as separate devices communicating through communication network(s) 210. Additionally, there may be more or fewer AI Tamer devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

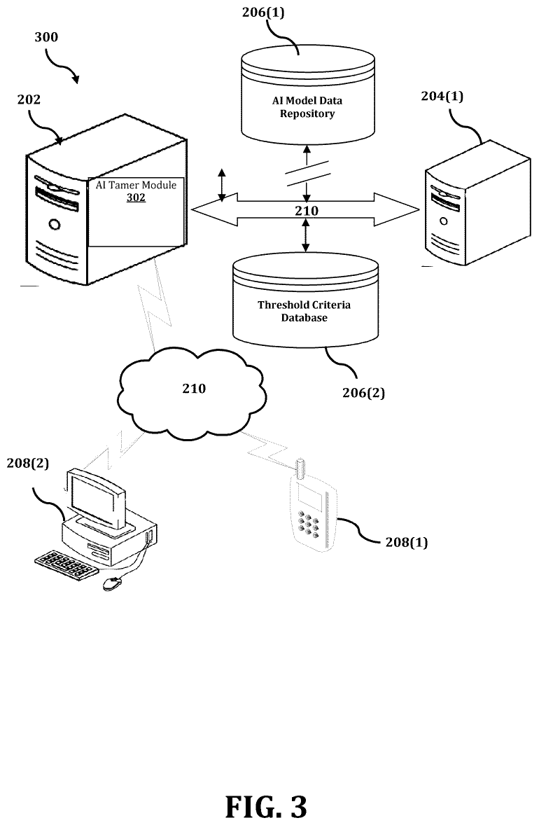

The AI Tamer device 202 is described and illustrated in FIG. 3 as including a AI Tamer module 302, although it may include other rules, policies, modules, databases, or applications, for example. As will be described below, the AI Tamer module 302 is configured to implement a method for using AI techniques to monitor the performance of an AI model and automatically perform an appropriate corrective action when necessary.

An exemplary process 300 for implementing a mechanism for using AI techniques to monitor the performance of an AI model and automatically perform an appropriate corrective action when necessary, by utilizing the network environment of FIG. 2 is illustrated as being executed in FIG. 3. Specifically, a first client device 208(1) and a second client device 208(2) are illustrated as being in communication with AI Tamer device 202. In this regard, the first client device 208(1) and the second client device 208(2) may be “clients” of the AI Tamer device 202 and are described herein as such. Nevertheless, it is to be known and understood that the first client device 208(1) and/or the second client device 208(2) need not necessarily be “clients” of the AI Tamer device 202, or any entity described in association therewith herein. Any additional or alternative relationship may exist between either or both of the first client device 208(1) and the second client device 208(2) and the AI Tamer device 202, or no relationship may exist.

Further, AI Tamer device 202 is illustrated as being able to access an AI model data repository 206(1) and a threshold criteria database 206(2). The AI Tamer module 302 may be configured to access these databases for implementing a method for using AI techniques to monitor the performance of an AI model and automatically perform an appropriate corrective action when necessary.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the AI Tamer device 202 via broadband or cellular communication. Of course, these embodiments are merely exemplary and are not limiting or exhaustive.

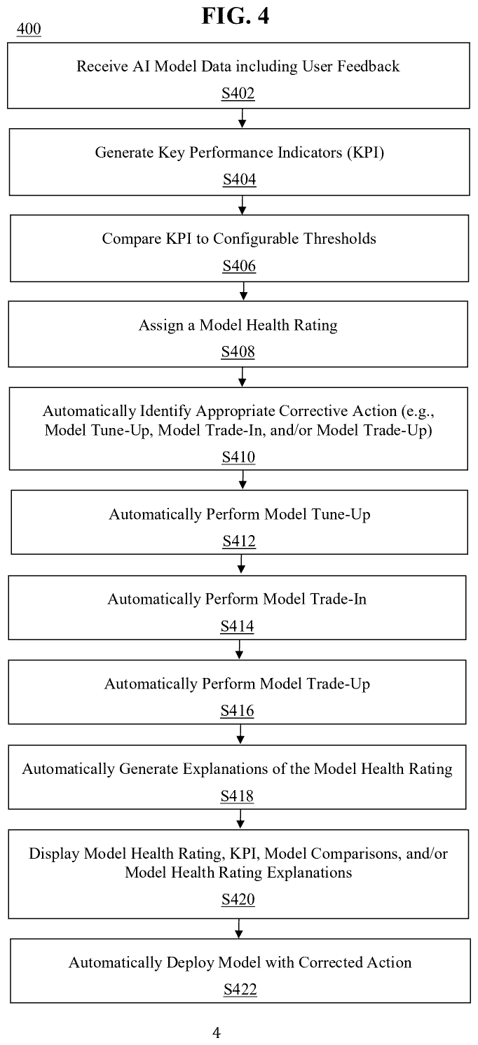

Upon being started, the AI Tamer module 302 executes a process for using AI techniques to monitor the performance of an AI model and automatically perform an appropriate corrective action when necessary. An exemplary process for using AI techniques to monitor the performance of an AI model and automatically perform an appropriate corrective action when necessary is generally indicated at flowchart 400 in FIG. 4.

In process 400 of FIG. 4, at step S402, the AI Tamer module 302 receives AI model data. In an exemplary embodiment, the AI model data may include all input, output, and/or processing data used, processed, and/or manufactured by the AI model and user's feedback which is the ground truth labelled data for the AI model. In an exemplary embodiment, the AI model data may relate to at least one account that is associated with an entity, such as a commercial entity or an individual person.

At step S404, the AI Tamer module 302 generates key performance indicators (KPI) for the AI model based on the received data. In an exemplary embodiment, the KPI may include at least one of precision, recall, specificity, accuracy, and an F1 score. In an exemplary embodiment, the AI Tamer module 302 may generate a confusion matrix that lists performance measurements with respect to the model (e.g., recall, specificity, precision, accuracy, etc.) and the model's KPI may be generated from the confusion matrix. In an exemplary embodiment, the precision is a measurement that relates a quality of a positive prediction made by the AI model. In an exemplary embodiment, the recall is a measurement that relates a percentage of relevant data points that are correctly identified by the AI model. In an exemplary embodiment, the specificity is a measurement that relates a proportion of true negatives that are correctly identified by the AI model. In an exemplary embodiment, the accuracy is a measurement that relates a percentage of classifications correctly identified by the AI model. In an exemplary embodiment, the F1 score is a popular KPI that is calculated from the recall and precision values.

At step S406 the AI Tamer module 302 compares the KPI to configurable thresholds. In an exemplary embodiment, the AI Tamer module 302 begins performing an automatic model inspection by comparing the generated KPI to the configurable thresholds. If the at least one KPI falls below a configurable threshold, the automatic inspection fails. In an exemplary embodiment, configurable tolerance thresholds are defaulted based on the baseline model KPI (e.g., F1) score.

Then, at step S408, the AI Tamer module 302 assigns a model health rating based upon the KPI comparison to the configurable thresholds. In an exemplary embodiment, the model health is determined in good health if the model KPI (e.g., F1) score exceeds the configurable tolerance threshold. The model health rating provides a three-way reconciliation between baseline model results, current model results, and human spot-check results. The three-way reconciliation may be used to determine if the model is behaving the same way as it used to. The three-way reconciliation may also be used to determine if the model is a good model (i.e., is it as good as, or better than, a human).

At step S410, the AI Tamer module 302 may automatically determine at least one type of corrective action to the AI model to increase the model health rating. In an exemplary embodiment, if the automatic model inspection fails (i.e., the model health rating is less than a predetermined minimum acceptable health rating), the model will attempt to self-heal (i.e., take corrective action) using a continuum of techniques including automatic model tune-up, automatic model trade-in, and automatic model trade-up. In an exemplary embodiment, if the automatic model inspection passes (i.e., the model health rating is greater than or equal to the predetermined minimum acceptable health rating), no corrective action is taken.

At step S412, the AI Tamer module 302 may perform automatic model tune-up. In an exemplary embodiment, AI Tamer automatically identifies the best probability thresholds using F1 Score, MCC, Euclidean distance in RoC curve, recall, precision, and specificity. For these four probability threshold points, AI Tamer calculates the KPI metric of the model, finds the best two probability threshold points and improves the precision of the probability threshold using a configurable precision parameter to obtain the optimal threshold point. This point is set as the optimal probability threshold that maximizes the KPI of the model.

At step S414, the AI Tamer module 302 may perform automatic model trade-in. In an exemplary embodiment, AI Tamer automatically retrains the model using new/second data, same features, same ML algorithm, performs hyper parameter tuning and selects the best model that maximizes the KPI of the model.

At step S416, the AI Tamer module 302 may perform automatic model trade-up. In an exemplary embodiment, AI Tamer automatically generates a new model using new/second data, identifies new features through feature engineering, trains multiple ML algorithms, performs hyper parameter tuning, selects best model that maximizes the KPI of the model.

At step S418, the AI Tamer module 302 generates an explanation of the model health rating. In an exemplary embodiment, if the model health rating is less than the predetermined minimum acceptable health rating, the AI Tamer modules 302 provides an explanation for the low health rating. In an exemplary embodiment, the explanation includes information that relates to feature weights used for determining the model health rating and a textual description that relates to how the feature weights have been determined.

At step S420, the AI Tamer module 302 displays, via the GUI, at least one of the model health rating, KPI, model comparisons, and model health rating explanations. In an exemplary embodiment, the GUI may display the feature weights used for determining the model health rating and the textual description that relates to how the feature weights have been determined.

In an exemplary embodiment, the GUI may display a chart or graph depicting global explainability indicating the influential features contributing to the model prediction. In an exemplary embodiment, the GUI may display a chart or graph depicting local micro-explainability model feature values versus the ground truth feature and median values. In an exemplary embodiment, the GUI may display a chart or graph depicting local micro-explainability indicating influential features contributing to model prediction. In an exemplary embodiment, the GUI may display a chart or graph depicting machine learning sampling of distributions of clusters of data represented in 3D space using autoencoders for an unsupervised model. In an exemplary embodiment, the GUI may display a chart or graph depicting cluster explainability showing feature importance in each data cluster. In an exemplary embodiment, the GUI may display a model inspection screen for the AI Tamer module 302, that visually displays the model health rating, KPI, and/or at least one statistical measurement depicting the status of the AI model.

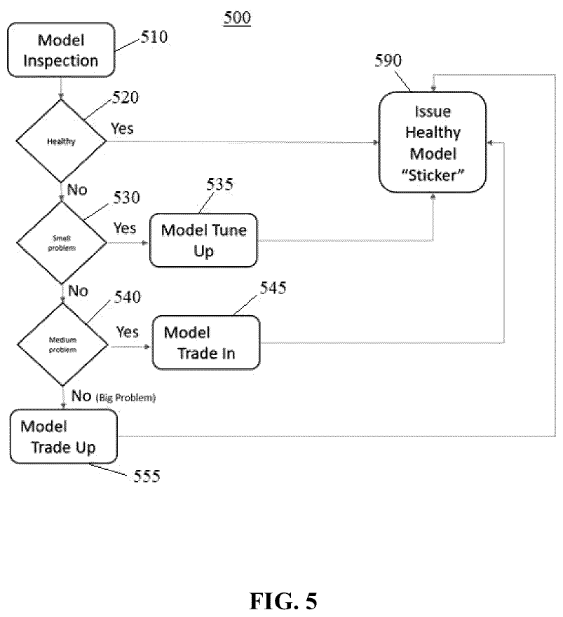

FIG. 5 is a flow diagram 500 that illustrates a process logic in a method for using AI techniques to monitor the performance of an AI model and automatically perform an appropriate corrective action when necessary, according to an exemplary embodiment. The first step is model inspection 510, where a model health rating is determined based upon the model's KPI (e.g., F1, precision, recall, specificity, and accuracy) versus configurable thresholds. Once the model health rating is determined, the system proceeds to step 520, where the AI Tamer evaluates whether the model is healthy. If yes, the model is healthy the system proceeds to step 590, and the model is issued a healthy model “sticker”. If no, the model is not healthy, the system proceeds to step 530. At step 530, the AI Tamer evaluates whether there is a relatively small problem with the model. If yes, there is only a small problem with the model, the system proceeds to step 535, and a model tune-up operation is performed. Once the model tune-up operation is performed, the system proceeds to step 590, and the model is issued a healthy model “sticker”. If no, the model does not have a small problem, the system proceeds to step 540. At step 540, the AI Tamer evaluates whether there is a medium-sized problem with the model. If yes, it is determined that there is only a medium-sized problem with the model, the system proceeds to step 545, and a model trade-in operation is performed. Once the model trade-in operation is performed, the system proceeds to step 590, and the model is issued a healthy model “sticker”. If no, the model does not have a medium-sized problem, the system proceeds to step 555, and a model trade-up operation is performed. Once the model trade-up operation is performed, the system proceeds to step 590, and the model is issued a healthy model “sticker”.

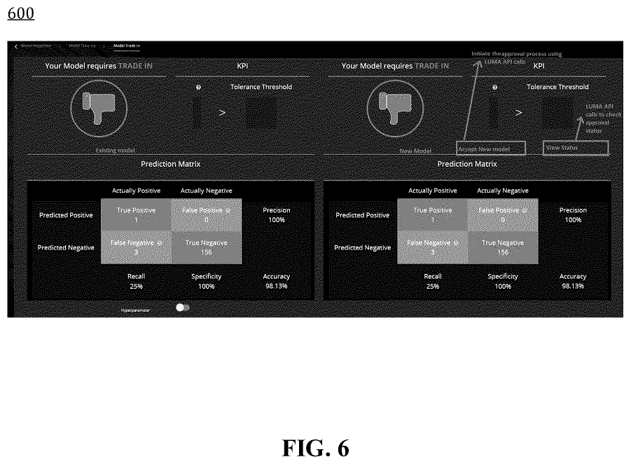

FIG. 6 is a screen shot 600 of a GUI displaying a set of metrics generated while executing a method for using AI techniques to monitor the performance of an AI model and automatically perform an appropriate corrective action when necessary, according to an exemplary embodiment. As illustrated in the screen shot 600, the GUI may include a visual representation of the model health rating (e.g., thumb up or thumb down). In an exemplary embodiment, the GUI may also contain visual representations that are color coded to represent the model health (e.g., the model health may be depicted as Green (healthy), Amber (medium health), or Red (unhealthy)). Additionally, as illustrated in the screen shot 600, the GUI may include text directly stating the status of the model (e.g., “Your model is healthy” or “Your model requires trade-in”). Furthermore, as illustrated in the screen shot 600, the GUI may include a visual representation of the prediction (i.e., confusion) matrix that relates to at least one KPI (e.g., F1, precision, recall, specificity, accuracy, etc.).

As described herein, various embodiments provide optimized methods and systems for using AI techniques to monitor the performance of an AI model and automatically perform an appropriate corrective action when necessary.

In an exemplary embodiment, a process for using AI techniques to monitor the performance of an AI model and automatically perform an appropriate corrective action, when necessary, may be implemented as an AI Tamer platform (“AI Tamer”).

The AI Tamer provides a scalable reusable platform for layman end-users to run a suite of AI models with the confidence that all the models behave as intended at all times, and demonstrably so. If the behavior of a model drifts outside of the acceptable range, it will automatically self-heal and return the intended behavior. The automatic self-healing process intuitively visualizes micro-explainability so that human quality assurance inspectors can double check, and optionally override, the automated process.

The automatic self-healing process also works in the event that a client requests that their data be forgotten as per GDPR regulation. In that case, the AI Tamer automatically removes the data, retrains itself without the forgotten data, and re-deploys itself. For each model in the suite, the AI Tamer includes a three-way reconciliation mechanism to understand whether the model behaves as expected. The three-way reconciliation compares current model results to both baseline model results and to human spot-checked results. If the model is not behaving as expected, the AI Tamer automatically takes corrective action to tune the model or to replace it with a new model which was automatically created by the system.

In accordance with various embodiments of the disclosure, the AI Tamer works by automatically maintaining models in a vast majority of situations. For example, in an exemplary embodiment, models can tune their own probability threshold, or they can retrain and redeploy themselves altogether.

To ensure that a user can understand and maintain control of the automatically self-healing models, the AI Tamer closes the gap between AI explainability (i.e., what data scientists understand) and AI interpretability (i.e., what laymen understand). In an exemplary embodiment, the AI Tamer may cause the models to visually generate an explanation of the original results, and automatically corrected results, in layman terms so that an untrained user may periodically verify and demonstrate model health.

In the unlikely event that a model does not fully self-heal, the AI Tamer puts tools in the hands of a user to take actions on an exception basis to improve model results as required via an automated governance workflow.

In an exemplary embodiment, the AI Tamer provides an array of benefits over non-self-healing models. Particularly, self-healing models eliminate manual model maintenance and run on autopilot in production. Additionally, without maintenance responsibility, data scientists are freed up to focus on new models. Furthermore, business teams can explain and control their tamed models with intuitive self-service tools. The AI Tamer may also identify surface hidden biases in the model results (e.g., racism, sexism, etc.), with deep micro-explainability. The AI Tamer may also cut user acceptance testing time by more than half as users quickly understand what they are getting because it is intuitively visualized and standardized. Additionally, the AI Tamer automates a controlled way to comply with GDPR's consumer “Right to be Forgotten.”

The AI Tamer solution provides a multitude of features for using AI techniques to monitor the performance of an AI model and automatically perform an appropriate corrective action when necessary, as detailed below.

Automatic model inspection: Provides a model health rating based upon the model's KPI (e.g., F1, precision, recall, specificity, accuracy, etc.) versus configurable thresholds. In an exemplary embodiment, the model health is determined in good health if the model F1 score exceeds the configurable tolerance threshold. The configurable tolerance threshold may be defaulted based on the baseline model F1 score. The AI Tamer also provides a three-way reconciliation between baseline model results, current model results, and human spot-check results. The three-way reconciliation answers the questions: Is the model behaving the same way as it used to? And is the model a good model, i.e., is it as good as, or better than, a human?

Automatic model tune-up: If an automatic model inspection fails, AI Tamer will attempt to self-heal itself using a continuum of techniques starting with the simplest one: automatic model tune-up. To execute a model tune-up, the system considers the following four methods to arrive at the optimal probability threshold.

1) Maximize F1 score: calculate the F1 score, precision and recall for a range of probability thresholds and choose the one which gives the maximum F1 score. F1 score is calculated using the harmonic mean of precision and recall.

F1=2*precision*recall/(precision+recall) (1)

2) Maximize the Matthews Correlation Coefficient (MCC): Calculate the confusion matrix for the range of probability thresholds and choose the one which gives the maximum MCC score.

MCC=(TP*TN−FP*FN)/√((TP+FP)(TP+FN)(TN+FP)(TN+FN)) (2),

where TP is true positive, FP is false positive, FN is false negative, and TN is true negative.

3) Minimize the Euclidean distance to arrive at the best position on the (Area under Curve: AUC/Receiver Operating Characteristics: ROC) curve that optimally balances True Positive Rate (TPR) and False Positive Rate (FPR). This best position sets the ideal probability threshold.

Euclidean distance=√[(FPR−0)²+(TPR−1)²] (3)

4) Maximum Precision/Recall/Specificity: Calculate the True Positive (TP), True Negative (TN), False Positive (FP), and False Negative (FN) for different values of probability thresholds and choose the probability thresholds which gives the maximum Precision value, Recall value, and Specificity value. Using these probability thresholds calculate the model KPI and choose the probability threshold that maximizes the KPI as the optimal probability threshold.

Precision=TP/TP+FP

Recall=TP/TP+FN

Specificity=TN/TN+FP

where TP is true positive, FP is false positive, FN is false negative, and TN is true negative.

In an exemplary embodiment, the AI Tamer chooses the optimal probability threshold using the points derived from the above four methods. Calculate the model KPI for the four probability threshold points obtained, identify the best two probability thresholds, say T1 and T2. Improve the precision of the probability threshold by testing the KPI metric value at intermediate points between T1 and T2. The number of intermediate points tested is controlled with a configurable precision parameter. First the middle point is tested and one point on either side of the middle point. Then the AI Tamer moves left or right depending which direction is producing a higher KPI. That process is repeated. The threshold point that maximizes the KPI of the model is automatically set as the optimal probability threshold value. Once the ideal probability threshold is set, all subsequent model inferences will use it. In an exemplary embodiment, after setting the probability threshold, the AI Tamer may automatically update both the confusion matrix and a list of items that the model recommends. In an exemplary embodiment, a user can optionally review the new setup before the next model inference and, on an exception basis, make a manual override to the automatically set probability threshold.

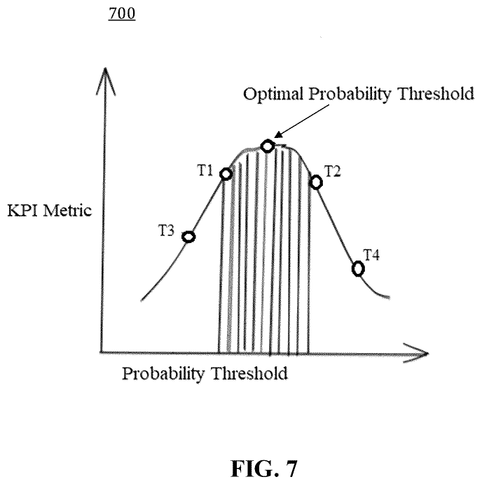

FIG. 7 is a graph 700 showing the distribution of four points for selecting the optimal probability threshold generated while executing a method for using AI techniques to monitor the performance of an AI model and automatically perform an appropriate corrective action when necessary, according to an exemplary embodiment. In an exemplary embodiment, the optimal probability threshold is selected using a point derived from each of the four metrics: Maximum F1 score, Maximum Matthews Correlation Coefficient (MCC), Minimum Euclidean distance, and Maximum Precision/Recall/Specificity. As shown in FIG. 7, each of the points T1, T2, T3, and T4 corresponds to one of the four metrics. In an exemplary embodiment, as illustrated in FIG. 7, the optimal probability threshold is selected an intermediate point between the best two probability thresholds (e.g., T1 and T2) that maximizes the KPI of the model.

Automatic model trade-in: If an automatic model inspection fails with a significant health issue (i.e., an issue too big for a tune-up with a probability threshold change), the AI Tamer will try an automatic model trade-in. To execute a model trade-in, the AI Tamer automatically retrains the model with a range of hyper-parameters on various sets of recent data and selects the best model.

Retraining the model is a more serious step than tuning the probability threshold, so in exemplary embodiments, the AI Tamer may require governance for this action. Therefore, after training a new model and generating the model artifacts, the AI Tamer automatically pushes the model through a governance process workflow after which it will automatically deploy the new model and use it for production inference.

In an exemplary embodiment, after the new model is generated, a user can optionally review the new model results in a side-by-side comparison with the current model results. The side-by-side model results comparison includes the primary KPI of the model (e.g., F1, precision, recall, accuracy, etc.) as well as an interactive confusion matrix and the list of model recommended items. The user is also presented with links to the complete history of the model including, the results of all previous experiments inclusive of at least one of the confusion matrix, F1, algorithm used, hyper-parameters, probability threshold, training data, test data, validation data, and data labels. The user also receives the recorded rationale for all decisions made during the training process. After digesting the model history and reviewing the proposed new model versus current model, the user can optionally decide to reject the new model and choose the automatic model trade-up option.

Automatic model trade-up: As with model trade-in, the AI Tamer retrains the model. However, in the model trade-up scenario, simply changing the hyper-parameters is insufficient so the AI Tamer implements feature engineering and trains on new features.

In exemplary embodiments, the feature engineering may be done by looking at all the fields available in the data and selecting the best feature-set to use. Several models are trained based on the selected feature-set and the tuned hyper-parameters. AI Tamer then chooses the best model among the several models trained based on the F1 score.

As with model trade-in, the user may optionally review the old versus new model results and optionally decide to reject the new model and select a different one.

Automatic model trade-up with derived features: As with the model trade-up, the AI Tamer does feature engineering and retrains the model, however, in this case, the AI Tamer uses derived features. The AI Tamer takes in the user provided derived features and retrains the model with the derived features. The optional user review and exception override process is the same as without derived features.

Automated right to be forgotten: If a client wishes to be forgotten (which is mandatory in the EU as part of the GDPR regulation), the AI Tamer automatically deletes the client's data from the training, test, and validation data sets. Then an automated pipeline automatically retrains the model and deploys it.

Automated model governance approval workflow: If the AI Tamer automatically tunes up a model, no governance is required. However, governance may be required whenever a model is retrained. Thus, the machine automatically retrains and deploys the model in a variety of ways to meet various circumstances. Whenever a retrain happens, it may need to be approved so AI Tamer kicks off an automated workflow. Governance comes in different heavier and lighter weight workflows depending on how big the action is and how critical the model functionality is (i.e., the risk level of the particular action and model combination). The riskier action generally requires more approvals and more high-level approvals.

Model micro-explainability: For each micro-decision (e.g., account-level decision), the model makes, AI Tamer graphically displays exact feature weights contributing to the model's decision and how the weights were determined. In an exemplary embodiment, the feature weights are used to estimate the relative importance of each feature (with respect to the task) and assign it a corresponding weight. In an exemplary embodiment, an important feature would receive a larger weight than less important or irrelevant features. The feature weights are identified with standard industry tools, but the GUI and workflow for presenting these values is unique (e.g., the GUI includes an interactive confusion matrix which automatically scales to any number of model classifications).

Furthermore, AI Tamer visualizes why the weights were selected by visually comparing the feature values of the item (e.g., account), to the values of both the general population and the values of the target populations (i.e., the values of the typical thing we are looking for).

Additionally, AI Tamer visualizes how differentiating the feature is by visualizing the median value of the general population versus the median value of the target population. If the two medians are close, it means that the feature is not very differentiating. If there is a significant difference between the medians, then the feature is very differentiating and will get a heavier weightage from the model.

The following key features of the model inspection screen are utilized in order: 1) Workflow to ensure that a human does a sampled portion of the machine's job manually on a periodic basis for periodic comparison against the machine's results. 2) The AI Tamer generates an interactive confusion matrix which uses the human results as the ground truth.

Recall, specificity, precision, and accuracy are all labelled on the matrix and hovering over these values uniquely highlights the relevant portions of the matrix so that a layman intuitively understands which portion is included without needing to know the mathematical formula. 3) The model's KPI is generated from the confusion matrix, for example, F1 score, a popular KPI, is calculated from the recall and precision values in the confusion matrix. 4) The model's KPI value is compared to configurable threshold values. Depending on the KPI value versus the threshold values, the model health may be depicted as Green (healthy), Amber (medium health), or Red (unhealthy). Prominent portions of the screen and graphics may be displayed in the proper color with visual cues (e.g., green thumbs up for healthy). The text on the screen may be direct: “Your model is healthy.” 5) The model's health is fed to a summary screen which lists all models and their health with colored health icons. In this way, it easy to identify whether any of the many models in the system is unhealthy and must be tended to. 6) If the model is healthy, or after it is fixed to be healthy, then it receives an inspection “sticker” saying when the model was inspected and by whom. If anything was fixed or noted, that is recorded. The sticker also says when the next inspection is due. As the due date approaches, escalating reminders are sent to ensure the model is inspected before the next inference.

Accordingly, with this technology, an optimized process for using AI techniques to monitor the performance of an AI model and automatically perform an appropriate corrective action when necessary is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for automatically monitoring a performance of an artificial intelligence (AI) model, the method being implemented by at least one processor, the method comprising:
receiving, by the at least one processor, first data that relates to an AI model;
generating, by the at least one processor based on the received first data, at least one key performance indicator (KPI) that relates to the AI model;
comparing, by the at least one processor, each of the at least one KPI to at least one configurable threshold;
assigning, by the at least one processor based on a result of the comparing, a model health rating; and
when the model health rating is less than a predetermined minimum acceptable health rating, performing, by the at least one processor, at least one corrective action that causes an increase in the model health rating.

2. The method of claim 1, wherein the performing of the at least one corrective action comprises applying an artificial intelligence (AI) algorithm that implements a machine learning technique with respect to a plurality of parameters associated with at least one from among the at least one KPI.

3. The method of claim 1, wherein the performing of the at least one corrective action comprises executing a model tune-up, the executing of the model tune-up comprising:
calculating, by the at least one processor, a respective F1 score, a respective Matthews Correlation Coefficient (MCC), a respective Euclidean distance, a respective recall, a respective precision and a respective specificity for each corresponding one of a predetermined range of probability thresholds;
identifying, by the at least one processor based on points derived from each of the F1 score, the Matthews Correlation Coefficient (MCC), the Euclidean distance, the recall, the precision and the specificity, a probability threshold;
generating, by the at least one processor based on the identified probability threshold for each of the F1 score, the Matthews Correlation Coefficient (MCC), the Euclidean distance, the recall, the precision and the specificity, an updated model KPI;
choosing, by the at least one processor based on the calculated updated model KPI, two of the identified probability thresholds;
improving, by the at least one processor, the precision of the two identified probability thresholds by finding a KPI metric value for a plurality of intermediate points between the two identified probability thresholds using a configurable precision parameter;
selecting, by the at least one processor, an optimal probability threshold value from the plurality of intermediate points with a maximum KPI metric value; and
updating, by the at least one processor, the AI model based on the selected optimal probability threshold value.

4. The method of claim 1, wherein the performing of the at least one corrective action comprises executing a model trade-in, the executing of the model trade-in comprising:
retraining, by the at least one processor, the AI model by using a range of hyper-parameters with respect to at least one set of second data that relates to the AI model and that has been generated more recently than the first data; and
deploying, by the at least one processor, a retrained version of the AI model.

5. The method of claim 4, wherein the performing of the at least one corrective action comprises executing a model trade-up, the executing of the model trade-up comprising:
identifying, by the at least one processor, a new feature-set from the second data;
training, by the at least one processor, a plurality of candidate AI models using the selected feature-set;
generating, by the at least one processor based on a result of the training, a respective KPI metric for each of the plurality of candidate AI models;
performing, by the at least one processor, hyper-parameter tuning of the plurality of candidate AI models by using a range of hyper-parameters;
selecting, by the at least one processor based on the generated respective KPI metric and the hyper-parameter tuning, a new AI model from among the plurality of candidate AI models; and
implementing, by the at least one processor, the selected new AI model.

6. The method of claim 1, wherein the at least one KPI includes at least one from among a precision of the AI model that relates to a quality of a positive prediction made by the AI model, a recall of the AI model that relates to a percentage of relevant data points that are correctly identified by the AI model, a specificity that relates to a proportion of true negatives that are correctly identified by the AI model, an accuracy that relates to a percentage of classifications correctly identified by the AI model, and an F1 score of the AI model that is calculable based on the precision and the recall.

7. The method of claim 1, further comprising displaying, via a graphical user interface (GUI), the model health rating.

8. The method of claim 7, further comprising generating an explanation with respect to the model health rating being less than the predetermined minimum acceptable health rating, and outputting the generated explanation to the GUI for display thereon.

9. The method of claim 8, wherein the explanation includes information that relates to feature weights used for determining the model health rating and a textual description that relates to how the feature weights have been determined.

10. A computing apparatus for automatically monitoring a performance of an artificial intelligence (AI) model, the computing apparatus comprising:
a processor;
a memory;
a display; and
a communication interface coupled to each of the processor, the memory, and the display,
wherein the processor is configured to:
receive, via the communication interface, first data that relates to an AI model;
generate, based on the received first data, at least one key performance indicator (KPI) that relates to the AI model;
compare each of the at least one KPI to at least one configurable threshold;
assign, based on a result of the comparing, a model health rating; and
when the model health rating is less than a predetermined minimum acceptable health rating, performing at least one corrective action that causes an increase in the model health rating.

11. The computing apparatus of claim 10, wherein the processor is further configured to perform the at least one corrective action by applying an artificial intelligence (AI) algorithm that implements a machine learning technique with respect to a plurality of parameters associated with at least one from among the at least one KPI.

12. The computing apparatus of claim 10, wherein the processor is further configured to perform the at least one corrective action by executing a model tune-up, and to execute the model tune-up by:
calculating a respective F1 score, a respective Matthews Correlation Coefficient (MCC), a respective Euclidean distance, a respective recall, a respective precision and a respective specificity for each corresponding one of a predetermined range of probability thresholds;
identifying, based on points derived from each of the F1 score, the Matthews Correlation Coefficient (MCC), the Euclidean distance, the recall, the precision and the specificity, a probability threshold;
generating, based on the identified probability threshold for each of the F1 score, the Matthews Correlation Coefficient (MCC), the Euclidean distance, the recall, the precision and the specificity, an updated model KPI;
choosing, based on the calculated updated model KPI, two of the identified probability thresholds;
improving the precision of the two identified probability thresholds by finding a KPI metric value for a plurality of intermediate points between the two identified probability thresholds using a configurable precision parameter;
selecting an optimal probability threshold value from the plurality of intermediate points with a maximum KPI metric value; and
updating the AI model based on the selected optimal probability threshold value.

13. The computing apparatus of claim 10, wherein the processor is further configured to perform the at least one corrective action by executing a model trade-in, and to execute the model trade-in by:
retraining the AI model by using a range of hyper-parameters with respect to at least one set of second data that relates to the AI model and that has been generated more recently than the first data; and
deploying a retrained version of the AI model.

14. The computing apparatus of claim 10, wherein the processor is further configured to perform the at least one corrective action by executing a model trade-up, and to execute the model trade-up by:
identifying a new feature-set from the second data;
training a plurality of candidate AI models using the selected feature-set;
generating, based on a result of the training, a respective KPI metric for each of the plurality of candidate AI models;
performing hyper-parameter tuning of the plurality of candidate AI models by using a range of hyper-parameters;
selecting, based on the generated respective KPI metric and the hyper-parameter tuning, a new AI model from among the plurality of candidate AI models; and
deploying the selected new AI model.

15. The computing apparatus of claim 10, wherein the at least one KPI includes at least one from among a precision of the AI model that relates a quality of a positive prediction made by the AI model, a recall of the AI model that relates a percentage of relevant data points that are correctly identified by the AI model, a specificity that relates a proportion of true negatives that are correctly identified by the AI model, an accuracy that relates a percentage of classifications correctly identified by the AI model, and an F1 score of the AI model that is calculable based on the precision and the recall.

16. The computing apparatus of claim 10, wherein the processor is further configured to cause the display to display, via a graphical user interface (GUI), the model health rating.

17. The computing apparatus of claim 16, wherein the processor is further configured to generate an explanation with respect to the model health rating being less than the predetermined minimum acceptable health rating, and to output the generated explanation to the GUI for display thereon.

18. The computing apparatus of claim 17, wherein the explanation includes information that relates to feature weights used for determining the model health rating and a textual description that relates to how the feature weights have been determined.

19. A non-transitory computer readable storage medium storing instructions for automatically monitoring a performance of an artificial intelligence (AI) model, the storage medium comprising executable code which, when executed by a processor, causes the processor to:
receive first data that relates to an AI model;
generate, based on the received first data, at least one key performance indicator (KPI) that relates to the AI model;
compare each of the at least one KPI to at least one configurable threshold;
assign, based on a result of the comparing, a model health rating; and
when the model health rating is less than a predetermined minimum acceptable health rating, perform at least one corrective action that causes an increase in the model health rating.

20. The storage medium of claim 19, wherein when executed by the processor, the executable code further causes the processor to perform the at least one corrective action by applying an artificial intelligence (AI) algorithm that implements a machine learning technique with respect to a plurality of parameters associated with at least one from among the at least one KPI.
